(19) United States
(12) Patent Application Publication
(10) Pub. No.: US 2026/0093299 A1
(43) Pub. Date: Apr. 2, 2026

(54) ELECTRONIC DEVICE

(71) Applicant: COMPAL ELECTRONICS, INC., Taipei City (TW)

(72) Inventors: Ko-Fan Chen, Taipei City (TW); Ming-Chung Peng, Taipei City (TW); Hui-Fang Huang, Taipei City (TW); Yi Hsiao, Taipei City (TW); Chih-Chin Chien, Taipei City (TW); Chia-Hsun Hsu, Taipei City (TW); Cheng-Yi Chiang, Taipei City (TW); Chen-Kuan Kuo, Taipei City (TW)

(73) Assignee: COMPAL ELECTRONICS, INC., Taipei City (TW)

(21) Appl. No.: 19/226,192

(22) Filed: Jun. 3, 2025

Related U.S. Application Data
(60) Provisional application No. 63/701,594, filed on Oct. 1, 2024.
(60) Provisional application No. 63/736,606, filed on Dec. 20, 2024.

(51) Int. Cl. G06F 1/20

(52) U.S. Cl. CPC G06F 1/203

(57) ABSTRACT

An electronic device includes a body having a front compartment and a rear compartment, at least one heat source, a circuit board, at least one first fan, and at least one second fan. The rear compartment extends from and is higher than the front compartment. The heat source, the circuit board, and the first fan are disposed within the front compartment. The first fan has first and second air outlets facing different directions. The circuit board, the first fan, and the body form an air chamber space communicated with an external environment through a first opening of the rear compartment and in which the heat source is located. The first fan provides a first airflow via the first air outlet adjacently connected to and facing the air chamber space, and generates a second airflow via the second outlet facing at least one second opening of the rear compartment to be discharged from the body.

### CROSS-REFERENCE TO RELATED APPLICATION

This application claims the priority benefit of U.S. Provisional Application No. 63/701,594, filed on Oct. 1, 2024 and U.S. Provisional Application No. 63/736,606, filed on Dec. 20, 2024. The entirety of each of the above-mentioned patent applications is hereby incorporated by reference herein and made a part of this specification.

### BACKGROUND

### Technical Field

The disclosure relates to an electronic device.

### Description of Related Art

As the performance of electronic devices continues to improve and their sizes continue to shrink, the electronic devices generate more heat during operation. However, the electronic devices lack sufficient space to install corresponding heat dissipation modules, making it difficult for the electronic devices to dissipate waste heat accumulated inside the casings, and temperatures inside the electronic devices also rise. In a high temperature environment, the computing performance of central processing units and graphics processing units is affected, which may even overheat, crash, or burn out.

Therefore, how to provide an optimized airflow heat dissipation path inside the electronic device to improve the heat dissipation efficiency and prevent the waste heat accumulation has become a topic that persons skilled in the related art need to consider.

### SUMMARY

The disclosure provides an electronic device, which utilizes a space of a rear compartment of a body and provides an optimized air chamber space within the body to improve the heat dissipation efficiency without increasing the thickness of the whole device.

An electronic device of the disclosure includes a body, at least one heat source, a circuit board, at least one first fan, and at least one second fan. The body has a front compartment and a rear compartment. The rear compartment extends from the front compartment and is higher than the front compartment. The heat source, the circuit board, and the first fan are disposed within the front compartment. The first fan has a first air outlet and a second air outlet facing different directions. The circuit board, the first fan, and the body form at least one air chamber space communicated with an external environment through a first opening of the rear compartment. The heat source is located in the air chamber space. The first air outlet of the first fan is adjacently connected to and faces the air chamber space to provide a first airflow to the air chamber space. The second air outlet of the first fan faces at least one second opening of the rear compartment to generate a second airflow to be discharged from the body. The second fan is disposed within the rear compartment to supply air to or discharge air from the air chamber space.

Based on the above, the electronic device may respectively provide spaces for configuring the first fan and the second fan through the configurations of the front compartment and the rear compartment of the body, and the structural feature of the rear compartment being higher than the front compartment. The circuit board, the first fan, and the body disposed within the front compartment form the air chamber space communicated with the rear compartment and the external environment. In this way, the second fan disposed within the rear compartment can enhance heat dissipation of the air chamber space through supplying air to or discharging air from the air chamber space to prevent waste heat from being retained in the body.

### BRIEF DESCRIPTION OF THE DRAWINGS

FIG. 1 is a schematic view of an electronic device according to an embodiment of the disclosure.

FIG. 2 illustrates the electronic device of FIG. 1 from another perspective.

FIG. 3 is a partial cross-sectional view of the electronic device of FIG. 1.

FIG. 4 illustrates some internal components of the electronic device of FIG. 1 from a top view.

FIG. 5 is a partial cross-sectional view of an electronic device according to another embodiment.

FIG. 6 is a top view of some components of an electronic device according to another embodiment.

FIG. 7 is a top view of some components of an electronic device according to another embodiment.

FIG. 8 is a top view of some components of an electronic device according to another embodiment.

FIG. 9A and FIG. 9B are respectively partial cross-sectional views of an electronic device according to different embodiments.

### DESCRIPTION OF THE EMBODIMENTS

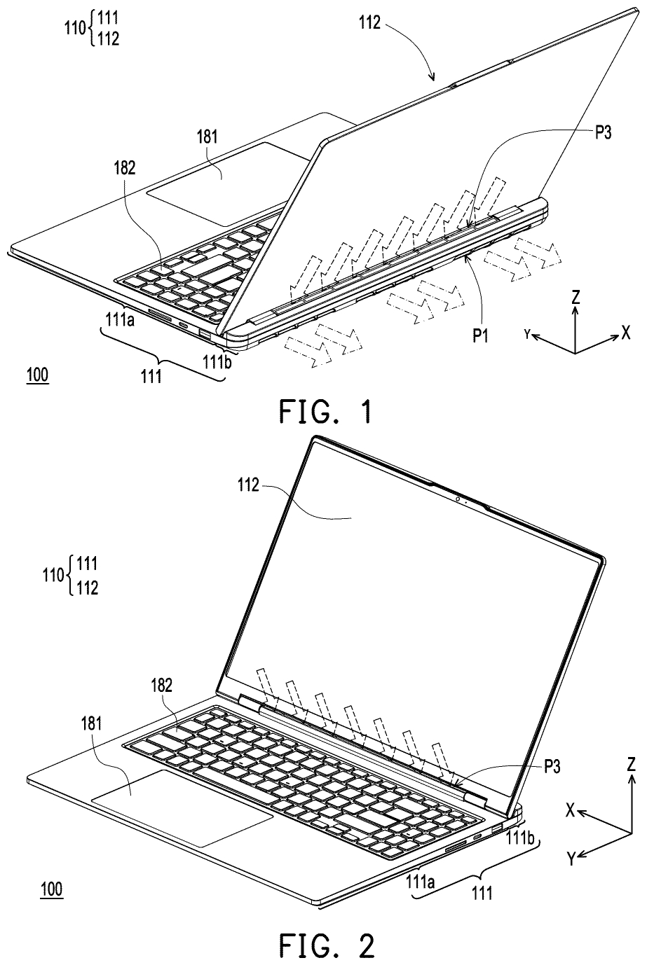

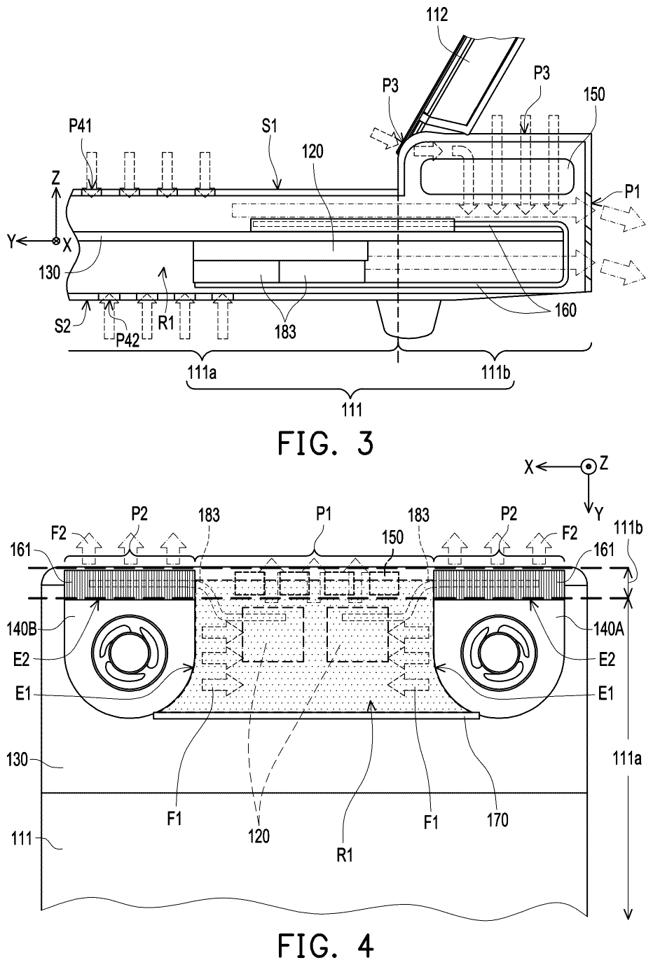

FIG. 1 is a schematic view of an electronic device according to an embodiment of the disclosure. FIG. 2 illustrates the electronic device of FIG. 1 from another perspective. FIG. 3 is a partial cross-sectional view of the electronic device of FIG. 1. Cartesian coordinates X-Y-Z are also provided here to facilitate component description. Please refer to FIG. 1 to FIG. 3 together. In the embodiment, an electronic device 100 is, for example, a notebook computer and includes an openable body 110 and is divided into a host 111 and a screen 112 pivotally connected to each other, wherein the host 111 is further divided into a front compartment 111a and a rear compartment 111b according to structural features thereof. The rear compartment 111b extends from the front compartment 111a and is higher than the front compartment 111a, and the screen 112 is pivotally connected to the rear compartment 111b. The electronic device 100 further includes a touch panel 181 and a keyboard 182, both of which are disposed within the front compartment 111a. In the embodiment, the plane of the host 111 is the X-Y plane or a plane parallel to the X-Y plane and is used as a reference to facilitate description of related components in the host 111.

FIG. 4 illustrates some internal components of the electronic device of FIG. 1 from a top view. Please refer to FIG. 3 and FIG. 4 together. Here, the related components are drawn in a simple diagram to prevent lines from interfering with each other due to being too complicated. In the embodiment, the electronic device 100 further includes a circuit board 130, a heat source 120, first fans 140A and 140B, and a second fan 150. The first fans 140A and 140B each have a first air outlet E1 and a second air outlet E2 facing different directions. The circuit board 130, the first fans 140A and 140B, and the host 111 of the body 110 form an air chamber space R1. The air chamber space R1 spans the front compartment 111a and the rear compartment 111b, and is communicated with an external environment through a first opening P1 of the rear compartment 111b. As shown in FIG. 3 and FIG. 4, the circuit board 130 is located on the X-Y plane, and the configuration directions of the first fans 140A and 140B in the host 111 of the body 110 are substantially parallel to the circuit board 130. In the embodiment, since the first fans 140A and 140B are embedded in the circuit board 130, the air chamber space R1 may cover spaces above and below the circuit board 130 in the Z-axis.

The heat sources 120 (two are shown, which are respectively, for example, a CPU and a GPU of a notebook computer) are located in the air chamber space R1. The first air outlet E1 is adjacently connected to and faces the air chamber space R1 to provide a first airflow F1 to the air chamber space R1. The second air outlet E2 of each of the first fans 140A and 140B faces a second opening P2 of the rear compartment 111b to generate a second airflow F2 to be discharged from the host 111 of the body 110. The second fan 150 is disposed within the rear compartment 111b, that is, located in a space where the rear compartment 111b is higher than the front compartment 111a and is used to supply air to or discharge air from the air chamber space R1, in order to dissipate heat from the air chamber space R1.

It should be noted that supplying air means that the fan directly provides forced cooling to the heat source 120 of the air chamber space R1, such as a heat pipe 183 and a heat dissipation fin 161 to be described later, through introducing cold air from the external environment; and discharging air means that the fan forcibly discharges heat absorbed by the air chamber space R1 to the external environment, and increases the flow of cold air (for example, the first airflow F1 and cold air drawn from fourth openings P41 and P42) through generating negative pressure. The disclosure does not only select one heat dissipation strategy of supplying air or discharging air for the air chamber space R1, but may also combine the two to dynamically adjust the heat dissipation strategy according to real-time temperature and system load, so as to achieve a mixed use with the optimal balance between efficiency, noise, and energy consumption. For example, if the notebook computer is under high performance load or in a high temperature external environment, the second fan 150 may adopt the heat dissipation strategy of discharging air; and if the notebook computer is under medium or low performance load or in a low temperature external environment, the second fan 150 may adopt the heat dissipation strategy of supplying air.

Furthermore, as shown in FIG. 4, the electronic device 100 further includes a baffle wall 170 abutted between the circuit board 130 and the host 111 of the body 110, and is adjacently connected between the two first fans 140A and 140B shown, so as to form the air chamber space R1 with the first fans 140A and 140B, the circuit board 130, and the host 111 of the body 110, that is, the baffle wall 170 may be regarded as one of multiple boundaries forming the air chamber space R1. The first opening P1 is located between two second openings P2, and the first opening P1 and the two second openings P2 are located on the same side of the rear compartment 111b. The two first fans 140A and 140B are respectively located at two opposite sides of the air chamber space R1, and the two first air outlets E1 face each other and are respectively adjacently connected to the air chamber space R1. Therefore, the first fans 140A and 140B may respectively provide the first airflow F1 to the air chamber space R1 when actuating. The second fan 150 corresponds to the air chamber space R1.

Furthermore, the position of the second fan 150 within the host 111 of the body 110 is higher than the positions of the first fans 140A and 140B within the body 110. The rear compartment 111b has a third opening P3 communicated with the external environment and corresponding to the second fan 150. The third opening P3 is substantially located at a raised part of the rear compartment 111b (relative to the front compartment 111a) and is different from the first opening P1 and the second opening P2. By referring to FIG. 2 to FIG. 4 together, it can be seen that in the height direction (positive Z-axis direction) of the body 100, the second fan 150 is substantially located between the third opening P3 and the first opening P1. Here, the second fan 150 includes multiple fan units, which are respectively an axial flow fan. As shown in FIG. 3, a top surface S1 and a bottom surface S2 of the front compartment 111a respectively have multiple fourth openings P41 and P42 for connecting to the external environment, wherein the fourth opening P41 of the top surface S1 is, for example, a gap formed between keys of the keyboard 182 shown in FIG. 1. The first opening P42 of the bottom surface S2 is, for example, an opening of the host 111 on the bottom casing thereof to draw cold air from the external environment into the host 111 respectively via the fourth openings P41 and P42 when the first fans 140A and 140B actuate.

In addition, the electronic device 100 further includes a heat conducting member 160 and a heat dissipation fin 161. One end of the heat conducting member 160 is located in the air chamber space R1 and thermally contacts the heat source 120 through the heat pipe 183. The heat pipe 183 substantially thermally contacts between the heat dissipation fin 161 and the heat source 120. The heat conducting member 160 extends from the front compartment 111a to the rear compartment 111b, so that the other end of the heat conducting member 160 is adjacent to the second fan 150. The heat dissipation fin 161 is disposed within the host 111 of the body 110 and is adjacently connected between the second opening P2 and the second air outlet E2.

Please refer to the airflow diagrams of FIG. 3 and FIG. 4 together. The second airflow F2 generated by the first fans 140A and 140B sequentially passes through the second air outlet E2, the heat dissipation fin 161, and the second opening P2 to be discharged from the rear compartment 111b, which serves as a first heat dissipation path for dissipating heat of the heat dissipation fin 161 (transferred from the heat source 120 to the heat dissipation fin 161 by the heat pipe 183) to the outside of the body 110. Furthermore, the first airflow F1 generated by the first fans 140A and 140B is first transmitted to the air chamber space R1 to absorb heat of the heat source 120, and is then pushed by air pressure to be discharged from the host 111 of the body 110 via the first opening P1, which may be regarded as a second heat dissipation path. More importantly, the second fan 150 of the embodiment supplies air to the air chamber space R1, so that cold air from the external environment may be drawn into the air chamber space R1 from the third opening P3 of the rear compartment 111b. As shown in FIG. 4, the second fan 150 corresponds to the position of the air chamber space R1. Therefore, cold air drawn into the air chamber space R1 by the second fan 150 may further cool the first airflow F1, the heat conducting member 160, and the heat pipe 183 that have absorbed heat, and also provide an air pressure pushing force that can discharge the first airflow F1 from the body 110, so as to enhance heat dissipation of the second heat dissipation path.

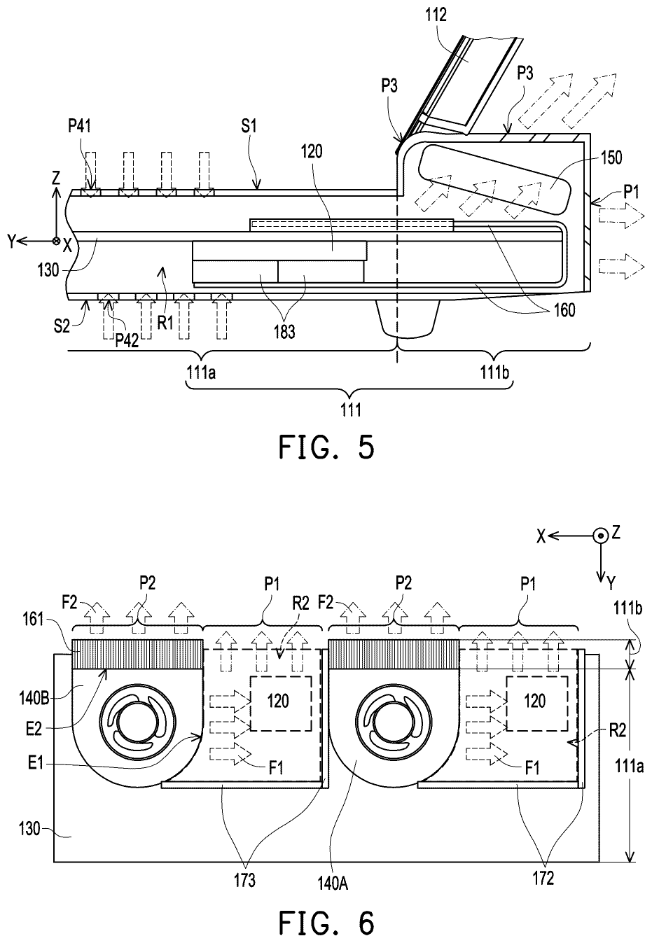

FIG. 5 is a partial cross-sectional view of an electronic device according to another embodiment. Please refer to FIG. 5 and compare with FIG. 3. The difference from the foregoing embodiment is that the second fan 150 of the present embodiment is used to discharge air from the air chamber space R1. Specifically, the first airflow F1 that has absorbed heat in the air chamber space R1 is further provided with an additional discharge path by the third opening P3 in addition to the original first opening P1, which increases negative pressure to more effectively enhance heat dissipation of the second heat dissipation path.

In addition to the heat dissipation strategy of dynamically adjusting air supply or air discharge, the heat dissipation strategy may also be dynamically adjusted according to an indicator to be optimized. Please refer to the table below, which is the experimental data of a notebook computer with a high power consumption design and the second fan 150 adopting air discharge, wherein the control group and the experimental groups all used the top surface S1 of the front compartment 111a as the measurement reference for temperature change, and adopted 3 small-sized second fans 150 arranged side by side.

| | Control | Experimental | Experimental | Experimental |
|---|---|---|---|---|
| | group | Group 1 | Group 2 | Group 3 |
| Second fan | Not started | Started | Started | Started |
| Top surface | 50 | 47 | 48.7 | 50 |
| temperature | | | | |
| (° C.) | | | | |
| Noise level | 55 | 55 | 50 | 55 |
| dB(A) | | | | |
| Thermal design | 160 | 160 | 160 | 170~172 |
| power TDP | | | | |
| (W) | | | | |

In the control group, in the state where operation of the second fan 150 was not started, the temperature of the top surface S1 was 50° C., the noise level was 55 dB (A), and the thermal design power was 160 W. In Experimental Groups 1 to 3 below, different control variables were tested when operation of the second fan 150 was started.

In Experimental Group 1, the control variables were set to the noise level of 55 dB (A) and the thermal design power of 160 W to have the same conditions as the control group. After actual measurement, the top surface temperature of the top surface S1 dropped to 47° C. compared with 50° C. of the control group, and the temperature dropped by about 3° C. It can be seen that in Experimental Group 1, under the conditions of maintaining the original noise level and the original performance, starting the second fan 150 for air discharge can indeed effectively improve the heat dissipation efficiency (that is, cooling optimization).

In Experimental Group 2, the control variable was only set to the thermal design power of 160 W to have the same condition as the control group. After actual measurement, the noise level was reduced to 50 dB (A) compared with 55 dB (A) of the control group, and the top surface temperature was slightly reduced to 48.7° C. compared with 50° C. of the control group. It can be seen that Experimental Group 2 can not only improve heat dissipation efficiency, but also provide the user with a quieter usage experience (low noise optimization) without sacrificing the operation performance.

In Experimental Group 3, the control variables were set to the top surface temperature of the top surface S1 of 50° C. and the noise level of 55 dB (A) to have the same conditions as the control group. After actual measurement, the thermal design power of Experimental Group 3 increased to about 170 W to 172 W. It can be seen that in Experimental Group 3, in the case where the top surface temperature of the top surface S1 is maintained and the noise level is tolerable, the processing performance can be further improved by 6% to 8% (operation performance optimization).

FIG. 6 is a top view of some components of an electronic device according to another embodiment. Please refer to FIG. 6 and compare with FIG. 4. Different from the foregoing embodiment, the first fans 140A and 140B of the present embodiment are arranged at intervals, that is, the first fans 140A and 140B are respectively matched with baffle walls 172 and 173 to form two air chamber spaces R2 independent of each other. Meanwhile, two heat sources 120 are respectively disposed within the two corresponding air chamber spaces R2, so that the first fan 140A is matched with the baffle wall 172 to dissipate heat for one of the heat sources 120, and the first fan 140B is matched with the baffle wall 173 to dissipate heat for the other one of the heat sources 120. In the embodiment, due to the configurations of the first fans 140A and 140B and the baffle walls 172 and 173, the two first openings P1 and the two second openings P2 are located on the same side of the rear compartment 111b and are staggered along the X-axis.

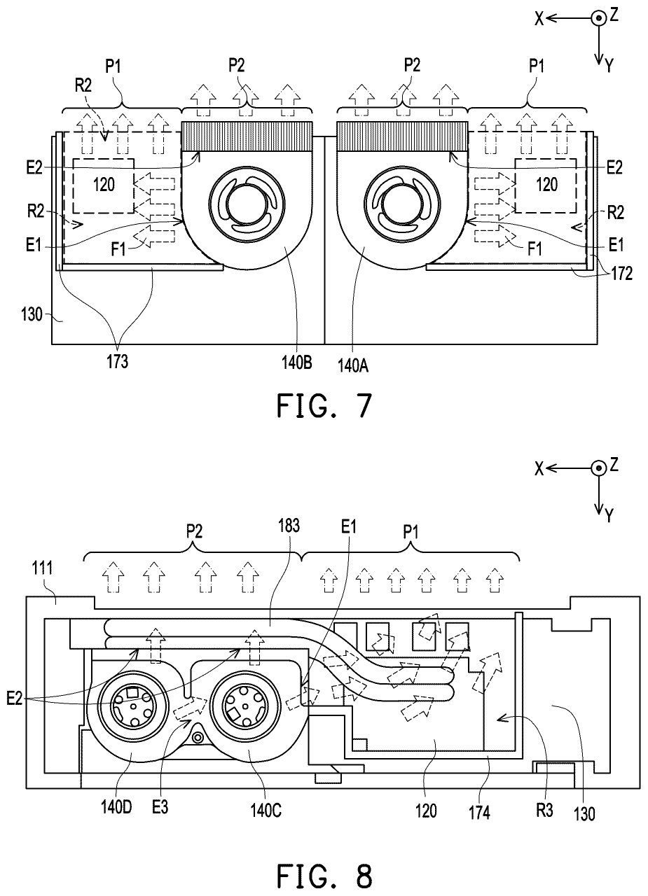

FIG. 7 is a top view of some components of an electronic device according to another embodiment. Please refer to FIG. 7 and compare with FIG. 6. In the present embodiment, the two independent air chamber spaces R2 are also formed by matching with the corresponding baffle walls 172 and 173, the two first openings P1 and the two second openings P2 are also located on the same side of the rear compartment 111b, and the two second openings P2 are adjacent to each other and located between the two first openings P1. Different from the foregoing embodiment, the first fans 140A and 140B of the present embodiment are adjacent to each other side by side, so that the air outlet directions of the two first air outlets E1 are along the X-axis but back facing each other as shown in the drawing.

In another embodiment not shown, a single first fan 140A or first fan 140B may be configured instead. The heat sources 120 are all placed in the same air chamber space R2.

FIG. 8 is a top view of some components of an electronic device according to another embodiment. Please refer to FIG. 8. Different from the foregoing embodiment, two first fans 140C and 140D of the present embodiment are arranged side by side and communicated with each other. Therefore, multiple second air outlets E2 shown are closely adjacent to each other along the X-axis, so that a part of airflows of the first fans 140C and 140D is discharged from the host 111 via the closely adjacent and side-by-side second air outlets E2 and second openings P2. On the other hand, for the first fan 140D on the left side of the drawing, a first air outlet E3 thereof is communicated with the first fan 140C on the right side, so that a part of the airflow of the first fan 140D can be used as the gain airflow of the first fan 140C, and the airflow provided by the first air outlet E1 of the first fan 140C on the right side is blown toward an air chamber space R3 formed by a baffle wall 174, the circuit board 130, and the host 111 of the body 110, and then discharged from the body 110 through the first opening P1 of the rear compartment 111b. A part of the airflow is transferred to the first fan 140C through the first fan 140D, thereby increasing the speed and the amount of the airflow discharged from the first fan 140C. Accordingly, the rear compartment 111b needs to be formed with the adjacent and side-by-side second openings P2 to correspond to the second air outlets E2 of the first fans 140C and 140D, and formed with the adjacent and side-by-side first openings P1 to correspond to the air chamber space R3.

Other similar fan configurations may be derived from the embodiment shown in FIG. 8, that is, multiple first fans may be arranged side by side and communicated with each other, and the first air outlet of only the first or the last first fan is connected to the air chamber space, so as to increase the speed and the amount of the airflow of the first or the last first fan through airflow accumulation. Correspondingly, the baffle wall 174 is adjacently connected next to the first air outlet of the first or the last first fan.

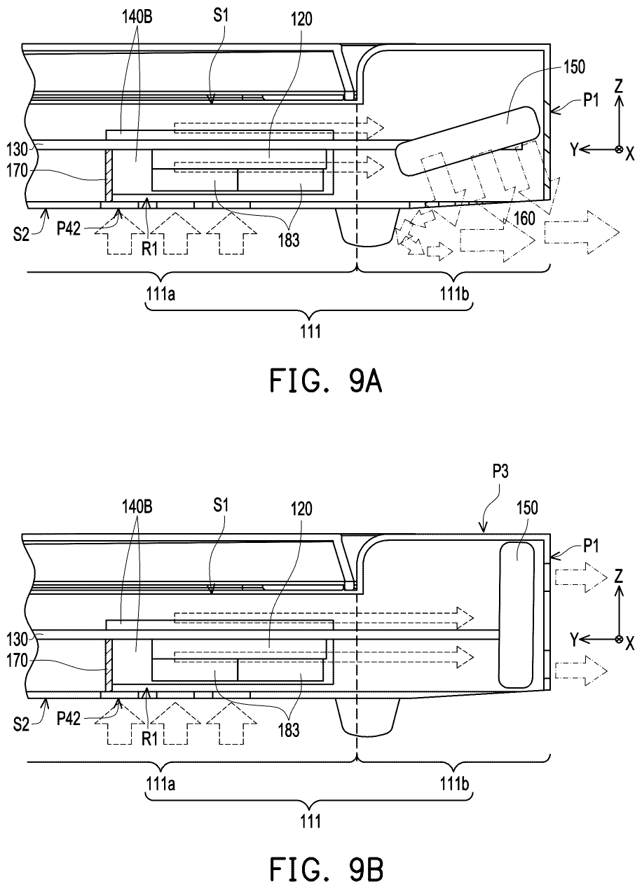

FIG. 9A and FIG. 9B are respectively partial cross-sectional views of an electronic device according to different embodiments. Please refer to FIG. 9A and compare with FIG. 3. Different from the foregoing embodiment in which the first fans 140A and 140B are embedded in the circuit board 130 in the Z-axis, and the second fan 150 is higher than the first fans 140A and 140B at the circuit board 130, the position of the second fan 150 within the body 110 of the present embodiment is at the same height as the positions of the first fans 140A and 140B in the body 110, and the second fan 150 is located in the air chamber space R1 adjacent to the first opening P1. In other words, the second fan 150 is directly placed in the second heat dissipation path to speed on the discharge of the first airflow F1 in the air chamber space R1 from the body 110.

In the embodiment of FIG. 9A, the rear compartment 111b has a fifth opening P5 located at the bottom, and the configuration direction of the second fan 150 within the body 110 is inclined to the configuration directions of the first fans 140A and 140B within the body 110. Please also refer to FIG. 9B. The second fan 150 is changed to be perpendicular to the configuration directions of the first fans 140A and 140B within the body 110, and the first opening P1 of the rear compartment 111b is used as the heat dissipation path. Compared with FIG. 9A, the air discharge path of the second fan 150 in FIG. 9B is the same as (that is, the air discharge path is parallel to and in the same direction as) the second heat dissipation path, which allows the first airflow F1 in the air chamber space R1 to be directly discharged from the first opening P1 of the rear compartment 111b without turning to the third opening P3 or the fifth opening P5, thereby enhancing the discharge efficiency of heat in the air chamber space R1.

In summary, in the foregoing embodiments of the disclosure, the electronic device may respectively provide spaces for configuring the first fan and the second fan through the configurations of the front compartment and the rear compartment of the body, and the structural feature of the rear compartment being higher than the front compartment, wherein the circuit board, the first fan, and the body disposed within the front compartment form the air chamber space communicated with the rear compartment and the external environment. Simply put, this solution utilizes the dual-air outlet characteristic of the first fan to provide the two different heat dissipation paths in the host of the body. One of which is matched with the heat pipe and the heat dissipation fin to transfer a part of the heat from the heat source to the heat dissipation fin via the heat pipe to be dissipated to the outside of the body. The other one is to enable the first fan, the circuit board, and the body to form the air chamber space by matching with the baffle wall, so that the heat in the air chamber space is discharged from the body through the airflow. More importantly, for the air chamber space, the second fan disposed within the rear compartment may further provide a gain effect, so as to speed up the dissipation of heat to prevent heat accumulation in the body.

What is claimed is:

1. An electronic device, comprising:
a body, having a front compartment and a rear compartment, wherein the rear compartment extends from the front compartment and is higher than the front compartment;
a circuit board, at least one heat source, and at least one first fan, respectively disposed within the front compartment, wherein the at least one first fan has a first air outlet and a second air outlet facing different directions, the circuit board, the at least one first fan, and the body cooperatively form at least one air chamber space, the at least one air chamber space is communicated with an external environment through at least one first opening of the rear compartment, the at least one heat source is located within the at least one air chamber space, the first air outlet is adjacently connected to and faces the at least one air chamber space to provide a first airflow to the at least one air chamber space, and the second air outlet faces at least one second opening of the rear compartment to generate a second airflow to be discharged from the body; and
at least one second fan, disposed within the rear compartment to supply air to or discharge air from the at least one air chamber space.

2. The electronic device according to claim 1, comprising two of the at least one first fan respectively located at two opposite sides of the at least one air chamber space, wherein two first air outlets of the two of the at least one first fan face each other and are respectively adjacently connected to the at least one air chamber space to respectively provide the first airflow to the at least one air chamber space, and the at least one second fan corresponds to the at least one air chamber space.

3. The electronic device according to claim 2, further comprising a baffle wall abutted between the circuit board and the body, and adjacently connected between the two of the at least one first fan, wherein the baffle wall is one of a plurality of boundaries forming the at least one air chamber space.

4. The electronic device according to claim 2, wherein the at least one first opening is located between two of the at least one second opening, and the at least one first opening and the two of the at least one second opening are located on the same side of the rear compartment.

5. The electronic device according to claim 1, comprising two of the at least one first fan arranged at intervals or adjacent to each other side by side, wherein the electronic device further comprises a plurality of baffle walls abutted between the circuit board and the body, and respectively corresponding to the two of the at least one first fan to form two of the at least one air chamber space independent of each other, and two of the at least one second fan respectively correspond to the two of the at least one air chamber space.

6. The electronic device according to claim 5, wherein the two of the at least one air chamber space are respectively communicated with the external environment through corresponding two of the at least one first opening, and two of the at least one second opening and the two of the at least one first opening are located on the same side of the rear compartment.

7. The electronic device according to claim 6, wherein when the two of the at least one first fan are arranged at intervals side by side, the two of the at least one first opening and the two of the at least one second opening are staggered with respect to each other.

8. The electronic device according to claim 6, wherein when the two of the at least one first fan are adjacent to each other side by side, the two of the at least one second opening are adjacent to each other and located between the two of the at least one first opening.

9. The electronic device according to claim 1, wherein the rear compartment has at least one third opening communicated with the external environment, corresponding to the at least one second fan, and different from the at least one first opening and the at least one second opening, and the at least one second fan is located between the at least one third opening and the at least one second opening.

10. The electronic device according to claim 1, wherein at least one of a top surface and a bottom surface of the front compartment has a plurality of fourth openings communicated with the external environment.

11. The electronic device according to claim 1, wherein a configuration direction of the at least one first fan within the body is parallel to the circuit board.

12. The electronic device according to claim 1, wherein a position of the at least one second fan within the body is higher than a position of the at least one first fan within the body.

13. The electronic device according to claim 1, wherein a position of the at least one second fan within the body is at the same height as a position of the at least one first fan within the body, and the at least one second fan is located in the at least one air chamber space adjacent to the at least one first opening.

14. The electronic device according to claim 1, wherein a configuration direction of the at least one second fan within the body is perpendicular to or inclined to a configuration direction of the at least one first fan within the body, and the at least one second fan is located in the at least one air chamber space adjacent to the at least one first opening.

15. The electronic device according to claim 14, wherein the configuration direction of the at least one second fan within the body is perpendicular to the configuration direction of the at least one first fan within the body, and the at least one second fan discharges the first airflow of the at least one air chamber space from the body through the at least one first opening.

16. The electronic device according to claim 1, wherein the at least one air chamber space spans the front compartment and the rear compartment.

17. The electronic device according to claim 1, wherein the body comprises a host and a screen, the host has the front compartment and the rear compartment, and the screen is pivotally connected to the rear compartment.

18. The electronic device according to claim 1, further comprising a heat conducting member, wherein one end of the heat conducting member is located in the at least one air chamber space and thermally contacts the at least one heat source, and the heat conducting member extends from the front compartment to the rear compartment so that the other end of the heat conducting member is adjacent to the at least one second fan.

19. The electronic device according to claim 1, further comprising a heat dissipation fin disposed within the body and adjacently connected between the at least one second opening and the second air outlet, wherein the second airflow sequentially passes through the second air outlet, the heat dissipation fin, and the at least one second opening to be discharged from the rear compartment.

20. The electronic device according to claim 1, wherein the at least one second fan comprises a plurality of fan units respectively being an axial flow fan.

21. The electronic device according to claim 1, comprising a plurality of the at least one first fan communicated with each other side by side, wherein a plurality of second air outlets of the first fans are closely adjacent to each other, and only the first or the last of the first fans is connected to the at least one air chamber space by the first air outlet.

22. The electronic device according to claim 21, further comprising a baffle wall abutted between the circuit board and the body, wherein the baffle wall is adjacently connected next to the first air outlet of the first or the last of the first fans.
